(19) United States
(12) Patent Application Publication
(10) Pub. No.: US 2003/0201880 A1
(43) Pub. Date: Oct. 30, 2003

(54) Automobile flat tires/blowout alert system

(76) Inventor: Chun-Ming Lu, Taoyuan (TW)

Correspondence Address: BRUCE E. TROXELL, Suite 1404, 5205 Leesburg Pike, Falls Church, VA, 22041, US

(21) Appl. No.: 10/118,973

(22) Filed: Apr. 10, 2002

(51) Int. Cl. B60C 23/00

(52) U.S. Cl. 340/443

(57) ABSTRACT

The present invention relates to an automobile flat tires/tire blowout alert system—a detecting system combining a micro-processor and several pairs of alert indicators with an ultrasonic sensor. With the ultrasonic sensor to detect the height variation between each tire and the ground, the system monitors the variation of the each tire's tire pressure. Then, after the micro-processor calculates and contrasts the detected status, the buzzer sends out alert signals and commands the alert indicators to signalize for identification, which in turn to maintain the security of the automobile's tires and prevent the them from being damaged.

### BACKGROUND OF THE INVENTION

Advanced and developing technology makes it possible to apply flexible and shock-absorption rubber tires to the tire rims of the automobile. In cooperation with a good carrying system, the tires provide smooth driving condition and labor-saving control. For the current high-performance tires and carrying system, however, if any tire goes flat because of insufficient tire pressure or blows out due to the puncture of sharp objects during driving, it is likely that the tires lets out the air slowly, rather than becomes flat immediately. Therefore, the puncture would be hard to detect if it is not serious which would take some time before the diver is aware of the punctuated tire. Under this condition, accident happens if the driver made an emergency brake during driving. As the result, the security becomes the primary consideration.

In view of the security problem caused by a flat or blowout, the inventor of the present invention was devoted to finding a solution—Automobile Flat Tire and Blowout Alert System—which provides real-time alert that warns the driver about the variation of the tire pressure, which in turn to prevent driving accidents.

### SUMMARY OF THE INVENTION

The technology of the present invention bases on the combination of the micro-processor and several pairs of alert indicators with the ultrasonic sensor. Then, with the ultrasonic sensor to detect the relative distance between the automobile's chassis and the ground, if that distance shortens because of the air leaking from the tire, the micro-processor would signalize different level of alert to the driver after contrasting it with the normal distance calculated by the micro-processor under the normal condition. This allows enough time for the driver to drive off the roadway, park and handle the situation or replace the tire immediately, which in turn avoids the danger during driving and the damage to the tire.

### BRIEF DESCRIPTION OF THE DRAWINGS

FIG. 1 is an ultrasonic sensor deployment illustration of the present invention.

FIG. 2 is an application illustration of the present invention on the four tires for detection.

FIG. 3 is a micro-processor component arrangement illustration of the present invention.

FIG. 4 is an indicating status illustration of the alert indicators for the present invention.

FIG. 5 is a height status illustration detected by the ultrasonic sensor under a normal tire condition.

FIG. 6 is a height status illustration detected by the ultrasonic sensor under the alert situation of a flat tire.

FIG. 7 is a height status illustration detected by the ultrasonic sensor under the situation of a blowout.

### DETAILED DESCRIPTION OF THE INVENTION

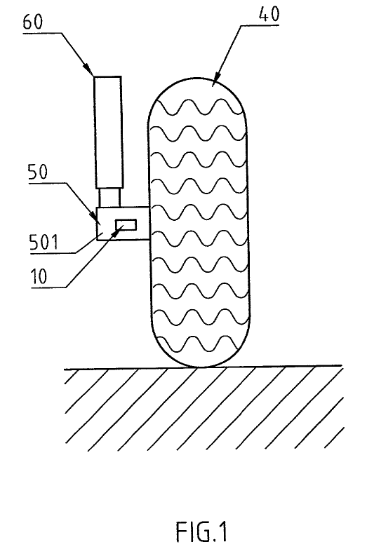

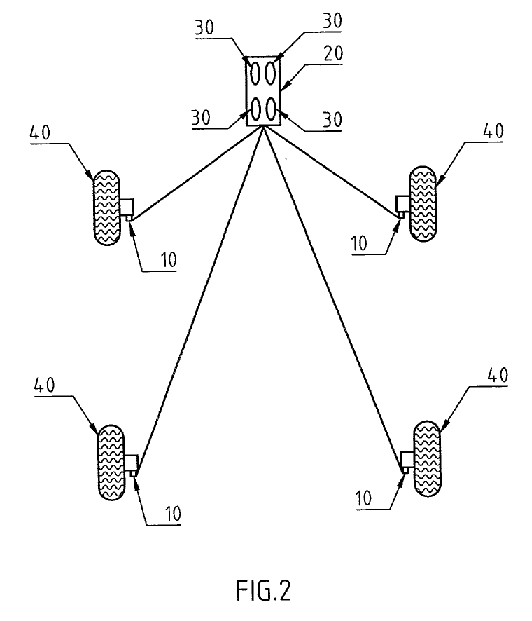

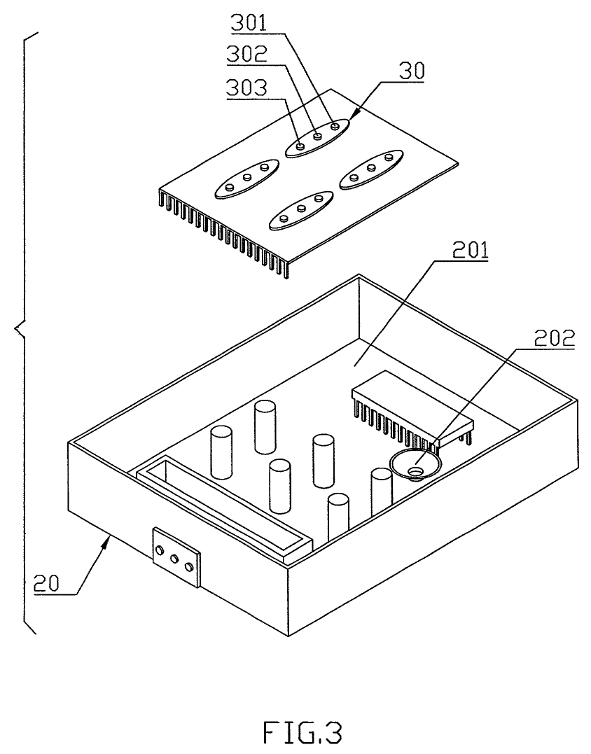

Please refer to FIGS. 1 to 3, the present invention of the automobile flat tire and blowout alert system is composed of several ultrasonic sensors 10, one micro-processor 20 and several pairs of alert indicators 30. The number of the ultrasonic sensors 10 varies with the number of the automobile's tires. Under the condition where several pairs of tires being located on the same side of the axle, the ultrasonic sensor 10—the ultrasonic distance measuring device made of piezoelectric ceramic—should be regarded as one pair and be inlaid inside the sealed rubber mask for security. Furthermore, the ultrasonic sensors 10 shall be placed above the tire's shaft and remains a relatively fixed distance from the center of the tire 40; therefore, the distance between the ultrasonic sensor 10 and the ground varies with the height between the tire 40 and the ground. As shown in FIG. 1, the ultrasonic sensor 10 shall be placed on the vertical side 501 of the seats of fixture of shock absorber 50 in order to protect it from the strike caused by crooked road and objects.

The micro-processor 20 mentioned above in which one integrated circuit 201 for calculation and contrast and one buzzer 202 for signalizing alert are attached lies nearby the dashboard, with an equal number of ultrasonic sensors 10 and alert indicators 30 on the external surface. Also, the integrated circuit 201 connects each pair of ultrasonic sensor 10 through wire leads to detect signal and then triggers the circuit of the buzzer 202 and of each pair of the alert indicators 30, which prompts the buzzer 202 to send out alert signal and put the lights of the alert indicators 30 on.

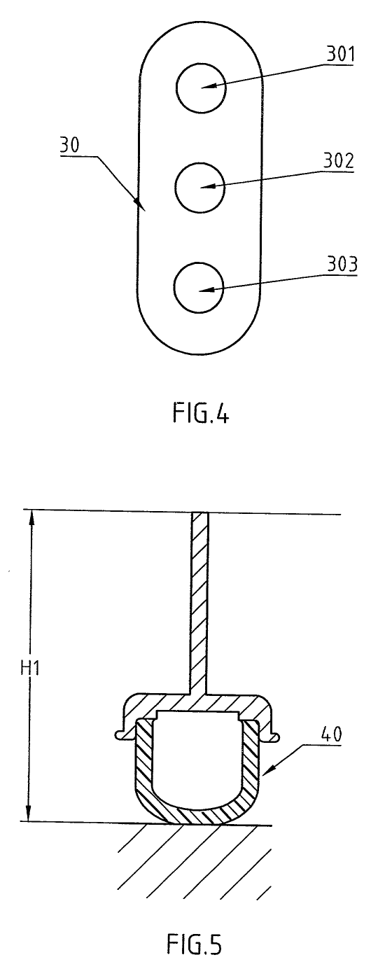

As shown in FIG. 4, each pair of alert indicator 30 mentioned above is equipped with the green indicator 301, the yellow indicator 302 and the red indicator 303 situated nearby the dashboard visibly, allowing the driver to be aware of the detection of the variation of the tire pressure.

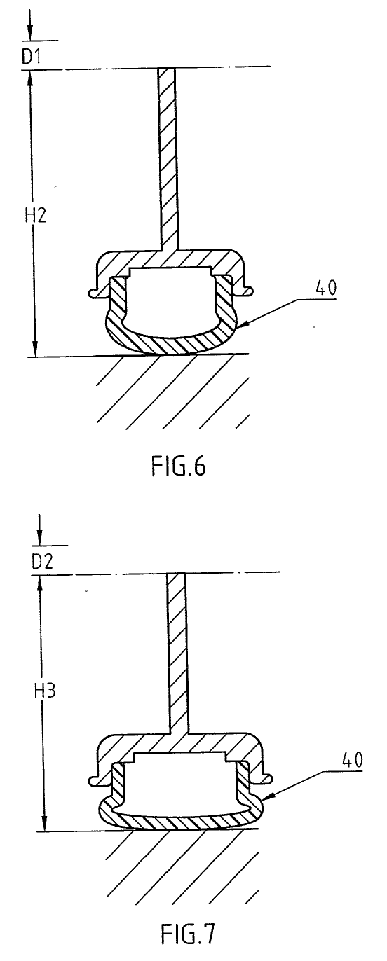

The present invention can be applied to different types of automobiles. Since each automobile possess different specifications of tires 40, which differentiate the height between the tires 40 and the ground, the distance between the ultrasonic sensor 10 and the ground changes with the height of the tire's shaft. Therefore, the ultrasonic sensor 10 placed above the tire's shaft is adjusted with the variation of the automobile's tires 40 during the configuration of its normal height. Please refer to FIGS. 5 and 6, use the micro-processor 20 to set up the three reaction distance range of the ultrasonic sensor 10 in accordance with the automobile being equipped. Among which, H1 refers to the height of a normal tire 40; H2, the maximum height of a flat tire 40, in which D1 means the contrast height compared with the height H1 of the normal tire 40; H3, the maximum height of the tire 40 that causes driving accidents where D2 is the contrast height compared with the height (H1) of the normal tire 40.

As mentioned above, when the pressure of the tire 40 changes and the tire goes flat during driving, whether caused by air leaked or being punctured by objects, the height between the tire 40 and the ground decreases, which means the height (H1) under the normal tire 40 condition measured by the ultrasonic sensor 10 reduces. The ultrasonic sensor 10 detects such variation in the height and sends out signal to the micro-processor 20 which then calculates and contrasts the height with the height (H1) of a normal tire 40. If the contrast value is less than D1, the air of the tire 40 is leaking slightly, which makes no influence to driving safety. In this case, the corresponding alert indicator 30 of the tire 40 remains at the green light 301.

If the tire 40 keeps letting out air with a contrast value larger than D1, the driver shall be aware of the status of the tire 40. In this case, the corresponding alert indicator 30 of the tire 40 changes to the yellow light 302 and the buzzer 202 starts to send out intermittent signals to remind the diver of refilling gas in the tire.

If the tire 40 is seriously punctuated with a contrast value higher than D2, the corresponding alert indicator 30 changes to the red light 303 and the buzzer 202 sends out strong signals to remind the driver to stop the car and handle the tire immediately.

The three situations above are those occurred to a driving automobile. If the driver gets into the automobile, switching on the circuit switch or starting the engine and finds the tire 40 leaking out air with a contrast value less than D2, then the yellow light 302 of the corresponding alert indicator 30 lights on and the buzzer 202 sends out intermittent signals to remind the driver of the flat tire 40 that should be repaired before driving. If the tire 40 is punctured by objects or remained letting out air overlong that the tire 40 has become totally flat, meaning a contrast value larger than D2, then the red light 303 of the alert indicator 30 corresponded to the tire 40 turns on and the buzzer 202 sends out strong and continuous signals to remind the driver of repairing immediately. In such a situation, the tire 40 is not appropriate for driving and should be replaced so as to prevent driving accidents or to save the tire 40 from damage.

What's more, the ultrasonic sensor 10 provided by the present invention can further be replaced with the infrared rays sensor, wireless sensor or laser sensor and then combined with one micro-processor and several pairs of indicators to form the same tire pressure detecting system for driving safety.

In conclusion, the automobile flat tire and blowout alert system provided of the present invention can be applied to any automobile for the detection of the tire status, and then achieves the objective of reminding and alerting the driver of danger, protecting the tires from damage that might in turn harms the whole structure.

What is claimed is:

1. An automobile flat tire and blowout alert system, consisting of several pairs of ultrasonic sensors of equal number with tires of an automobile, one micro-processor and several alert indicators, characterized in that:
said ultrasonic sensor is an ultrasonic distance measuring device made of piezoelectric ceramic, it is placed above a shaft of said tire to protect itself from damage caused by objects on the ground, while keeping at a fixed distance from a center of said tire that allows distance between said sensor and the ground to change with height between said tire and the ground;
a micro-processor lies beneath a dashboard of said automobile, in which one integrated circuit for calculation and contrast and one buzzer for sending out alert signals are attached and alert indicators of equal numbers with said ultrasonic sensors inlay on a surface, said integrated circuit connects each pair of ultrasonic sensor through wire leads for detecting signals and then triggers said circuit of said buzzer and of each pair of said alert indicators, which prompts said buzzer to send out alert signals and put lights of said alert indicators on;
as such, said invention detects variation of height between each tire and the ground with said ultrasonic sensor, and said ultrasonic sensor in turn monitors variation of tire pressure, then, in accordance with a detected status calculated and contrasted by said micro-processor, said buzzer sends out alert signals and triggers each indicative light of said alert indicators so as to protect the driver during driving by maintaining security of said tire.
